(19) United States
(12) Patent Application Publication
(10) Pub. No.: US 2014/0328485 A1
(43) Pub. Date: Nov. 6, 2014

(54) SYSTEMS AND METHODS FOR STEREOISATION AND ENHANCEMENT OF LIVE EVENT AUDIO

(71) Applicant: NVIDIA Corporation, (US)

(72) Inventor: Scott SAULTERS, Taipei (TW)

(73) Assignee: NVIDIA Corporation, Santa Clara, CA (US)

(21) Appl. No.: 13/887,598

(22) Filed: May 6, 2013

(51) Int. Cl. G06F 3/16

(52) U.S. Cl. CPC G06F 3/165
USPC 381/17; 381/119; 381/107

(57) ABSTRACT

Systems and methods to deliver live sound with enhanced quality conveyed by a mixing desk to a mobile computing device user contemporaneously with external live sounds. The mobile computing device is operable to receive enhanced audio signals produced by a remote audio signal processing device through a communication work. A memory resident application is configured to playback the enhanced audio signals in phase with the external sounds using an audio rendering device. An attendee at the live event can hear the sounds from the playback through an earphone coupled to the mobile computing device as well as from the ambient environment.

### TECHNICAL FIELD

Embodiments of the present disclosure relate generally to computing device applications and, more particularly, to application programs related to music listening.

### BACKGROUND

A live performance event, e.g. a concert, usually employs an audio system comprising an array of on-stage microphones, a mixing desk, and a plurality of amplifiers. Typically each microphone is used to convert one or more sounds to a channel of audio signals to be delivered to the mixing desk, the sounds originated from voices, instruments, or prerecorded material. The mixing desk may be a mixing console and capable of mixing, routing, and changing the level, timbre, and/or dynamics of the audio signals. Each channel also has several variables depending on the mixing desk's size and capacity. Such variables can include volume, bass, treble, effects and others. A live sound engineer can operate the mixing desk to balance the various channels in a way that best suits the need of the live event. The signals produced by the mixer are often amplified, e.g. by the amplifier, especially in large scale concerts.

Although the mixing desk can process and reproduce the sounds in real-time with enhanced audio effects, such as stereo effects, the attendees of a live concert typically do not enjoy the benefits of the high quality conveyed by the mixing desk due to a number of factors, including overloud volumes, performers' movements on the stage, crosstalk between channels, phase cancellation, unpredictable environments, listener's moving positions, etc. For example, because each loudspeaker generates very loud sound, an attendee can only hear the performance primarily from the closest loudspeaker and thus without stereo effects. In other words, the sound quality perceived by the audience at a concert event is usually significantly inferior to the recorded audio at the mixing desk.

### SUMMARY OF THE INVENTION

Therefore, it would be advantageous to provide a mechanism to deliver high quality live sound to an audience at a concert event without removing the feel of being in a live event.

Accordingly, embodiments of the present disclosure provide systems and methods to deliver real-time performance audio with enhanced quality imparted by the mixing desk to an audience member at a live event. In accordance with an embodiment, the processed audio signals generated by a mixing desk are instantaneously sent to a mobile computing device possessed by an attendee. The mobile computing device can play back the processed audio signals contemporaneously with the external live sounds emitted from loudspeakers at the live event. By using an earphone that permits external sounds to penetrate, the attendee can hear the playback sounds in phase with the external sounds from the loudspeakers. Thereby, the attendee can enjoy both high quality sounds and the exciting atmosphere of the live event. In one embodiment, open back earphones can be used.

In one embodiment of present disclosure, a mobile computing device comprises: a processor coupled to a memory and a bus; a display panel coupled to the bus; an audio rendering device; an Input/Output (I/O) interface configured to receive enhanced audio signals from a communication network. The enhanced audio signals represent external sounds that are substantially contemporaneously audible to a user and comprise enhanced audio effects relating thereto. The enhanced audio signals are provided by a remote audio signal processing device. The mobile computing device further comprises a memory resident application configured to play back the enhanced audio signals in phase with the external sounds using the audio rendering device. The remote audio signal processing device may be a mixing console coupled with the loudspeaker and the communication network. The communication network may be a local area network (LAN). The memory resident application may be operable to adjust volume of the playback to balance volume level of the enhanced audio signal with contemporaneously detected volume level of an earphone. The resident application may be further operable to synchronize the playback with the external sounds.

In another embodiment of present disclosure, a computer implemented method of providing real-time audio with enhanced sound-effects using a portable computing device comprises: (1) receiving real-time audio data from a communication network at the portable computing device, where the real-time audio data represent concurrent external sounds that are audible to a user of the portable computing device and comprising enhanced sound-effects relating thereto, and where the real time audio data are provided by a remote audio production console; and (2) using a memory resident application to play back the real-time audio data, where the playing back is in phase with the concurrent external sounds. The method may further comprise determining a time delay and adding it to the playback of the real-time audio data. The method may further comprise balancing volume levels of the playback with a detected volume of the concurrent external sounds. The method may further comprise receiving a user request at a mobile computing device to adjust the real-time audio data and forward the user request to a remote computing device. The remote computing device may be operable to further adjust sounds effects to the real-time audio data in response to the user request.

In another embodiment of present disclosure, a tangible non-transient computer readable storage medium having instructions executable by a processor, the instructions performing a method comprising: (1) rendering a graphic user interface (GUI); (2) receiving real-time audio data from a communication network at a portable computing device comprising the processor, the real-time audio data representing concurrent external sounds that are audible to a user of the portable computing device and comprising enhanced sound-effects, the real-time audio data provided by a remote audio production console; and (3) playing back the real-time audio data substantially in phase with the concurrent external sounds.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a block diagram showing an exemplary configuration of a live event audio system capable of providing enhanced sound effects to attendees through mobile computing devices in accordance with an embodiment of the present disclosure.

FIG. 2 is a flow chart depicting an exemplary computer implemented method of providing processed audio data to mobile computing devices possessed by attendees at a concert event in accordance with an embodiment of the present disclosure.

FIG. 3 is a flow chart depicting an exemplary computer implemented method of synchronizing the mobile device output with the external sounds at a live event in accordance with an embodiment of the present disclosure.

FIG. 4 is a flow chart depicting an exemplary method of balancing the volume levels of the mobile device output and the external sounds in accordance with an embodiment of the present disclosure.

FIG. 5 illustrates an exemplary on-screen GUI configured to receive user control to personalize sound effects of the mobile computing device audio output in accordance with an embodiment of the present disclosure.

FIG. 6 is a flow chart depicting an exemplary method to provide personalized audio effect to an attendee during a live event by using a mobile computing device in accordance with an embodiment of the present disclosure.

FIG. 7 is a block diagram illustrating an exemplary configuration of a mobile computing device configured with an application to provide live audio with enhanced audio effects to a user in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

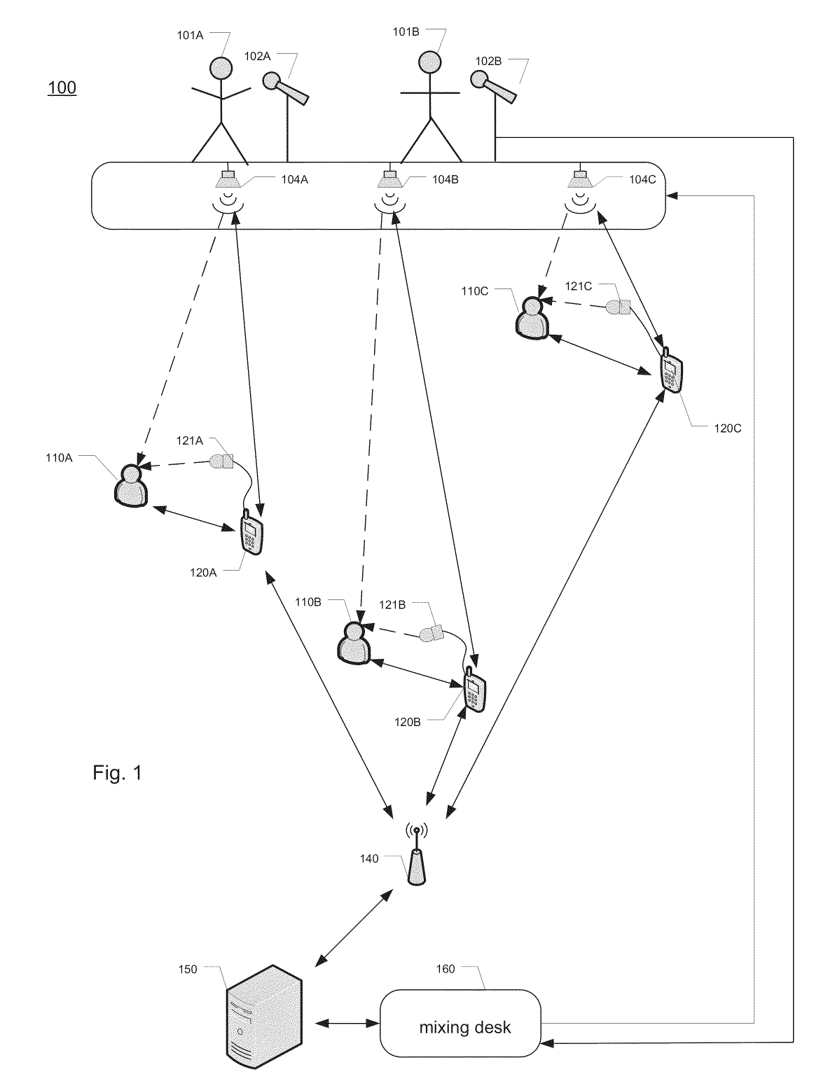

FIG. 1 is a block diagram showing an exemplary configuration of a live event audio system 100 capable of providing enhanced sound effects to attendees 110A-C through mobile computing devices 120A-C in accordance with an embodiment of the present disclosure. The exemplary audio system 100 includes amplifiers or loudspeakers, 104A-C coupled to on-stage microphones 102A and 102B, and a mixing desk or console 160 coupled to the loudspeaker 104A-C and the on-stage microphones 102A and 102B. The mixing desk 160 is further coupled to a server computer 150, a wireless network access point 140, and personal mobile computing devices 120A-C equipped with earphones 121A-C respectively.

In the illustrated example, the live event audio system 100 is utilized in a live concert by two vocalists 101A and 101B and other instrument players on stage (not shown). The voices of the vocalists 101A and 101B and the music sounds of the instruments are converted to a stream of audio signals through a plurality of on-stage microphones including 102A and 102 B and others placed near the instruments. The stream of audio signals, comprising a plurality of channels corresponding to the plurality of on-stage microphones, are provided to the mixing desk 160 for processing. The attendees 110A, 110B, and 110C sit and/or stand in different locations at the concert relative to the stage, each possessing a respectively mobile computing device 120A, 120B or 120C that that is connected with an earphone 121A, 121B, or 121C. In one embodiment, the earphone is an open back earphone.

The mixing desk 160 may be a mixing console and capable of electrically combining the multiple-channel audio signals to generate mixed audio signals in accordance with an mixer technician to produce an output, e.g. the main mix. The main mix can then be amplified and reproduced via an array of loudspeakers 104A-C to generate the external sounds audible to the attendees 110A-C through the ambient environment. These external sounds may be monophonic.

Receiving the multiple channel audio signals, the mixing desk 160 can generate a number of audio outputs by virtue of subgroup mixing, the subgroup number ranging from two to hundreds, as dictated by the designer and engineer's need for a given situation. For example, a basic mixing desk can have two subgroup outputs designed to be recorded or reproduced as stereo sounds. Contemporaneously with the combined audio output sent to the amplifies, e.g. the main mix, a selected number of audio outputs from the mixing desk can be transmitted in real-time to the mobile computing devices 120A-C through a wireless communication network.

The mobile computing devices 120A-C can then play back the audio outputs substantially instantaneously and deliver sounds with enhanced effects imparted by the mixing desk, such as stereo effects, to the attendees 110A-C through associated earphones 121A-C. In some embodiments, the earphones 121A-C may comprise open-back style headphones or ear buds and also permit external sounds to enter the ear canals of the attendees 110A-C. The earphones 121A-C may communicate with the mobile devices through a wire connection or wireless connection. Therefore, by virtue of using their mobile computing devices, the attendees are advantageously able to enjoy the live performance with enhanced listening experiences without losing the loudness or exciting live feel of the performance.

The mechanism of using a mobile computing device to receive contemporaneous external sounds with added enhanced effects as disclosed herein can be applied in a variety of contexts, such as a live performance, a conference, an assembly, a sport event, a meeting, a news reporting event, and home entertainment, either amplified or not. The term “live” should be understood to refer to real-time external sounds which may represent the replay of earlier-recorded audio content. The audio content may contain any sounds, e.g. music, speech, or a combination thereof.

In the illustrated embodiment, the communication channel between the mixing desk 160 and the mobile computing devices 120A-C comprises a server computer and a local area network (LAN) connecting the server computer 150 and the mobile devices 120A-C. The LAN may be established by a wireless network access point. In some other embodiments, the server 150 and the mobile devices 120A-C may communicate via wide area network (WAN) or any other types of network. In any of these scenario, the network may be secured and only accessible by users who can provide a password specified for a particular concert.

The server computer 150 may be a device located at the venue of the live event. Alternatively, it may be a separate server device or integrated with the mixing desk. In some other embodiments, it can be a remote computing server.

The server computer 150 can be used to individually adapt the number of audio outputs from the mixing desk 160 for transmission to the mobile computing devices 120A-C. In some embodiments, the server computer 150 may further process the received audio signals in accordance with a preconfigured set of processing parameters and broadcast or multicast the same processed audio data to the mobile devices, e.g. 120A-C.

Further, as will be described in greater details herein, the audio system 100 can take the advantage of the server computer's processing power and use it to further process the stream of audio signals responsive to an individual attendee's instructions sent from individual mobile devices, e.g. 120A. In such embodiments, the server computer 150 may send customized audio data to individual mobile devices via unicast. in particular, the server computer may customize individual audio signal transmitted to a specific mobile device based on: (1) the position of the specific mobile device with respect to the closest loudspeaker; (2) the volume of ambient music detected by the specific mobile device.

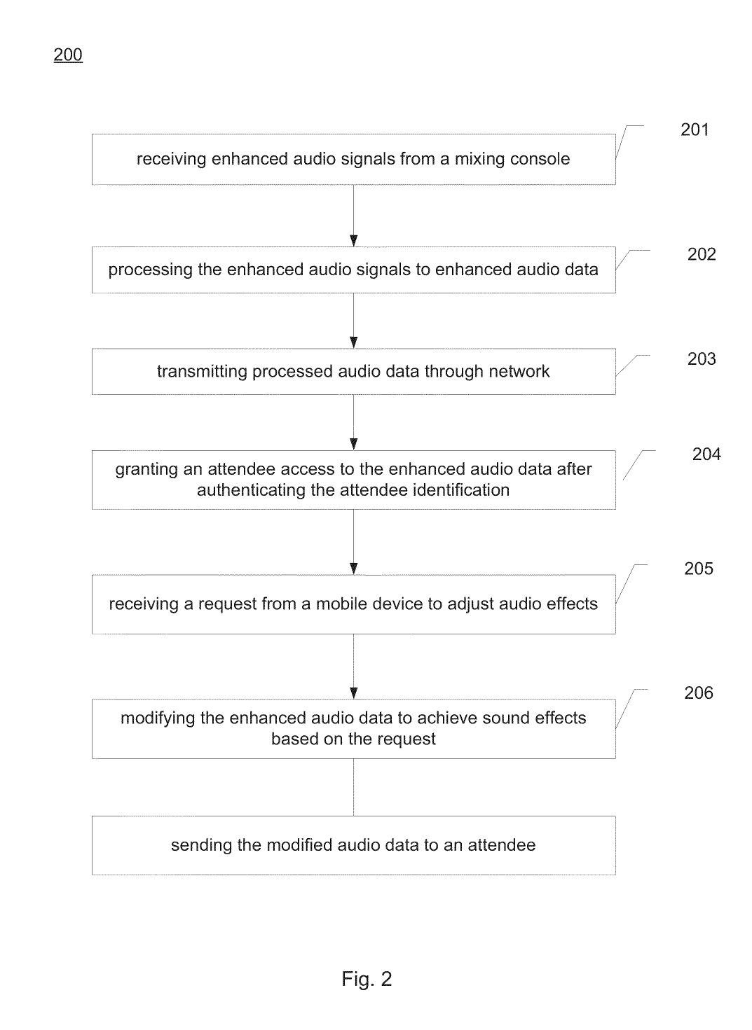

FIG. 2 is a flow chart depicting a computer implemented method 200 of providing processed audio data to mobile computing devices possessed by attendees in accordance with an embodiment of the present disclosure. At 201, the sever computer receives audio signals from multiple outputs of a mixing console and process the audio signals, such as analog/digital conversion (ADC) and encoding, to generate processed audio data at 202. The processed audio data are transmitted through the LAN at 203. When receiving a user request for access to the processed audio data, the server computer may grant the access after authenticating the user identification at 204. Further, when receiving a user request to adjust an audio effect in a specific manner at 205, the server may modify the audio data based on the request at 206.

In some other embodiments, the mixing desk may be able to generate digital audio outputs that can be communicated with the mobile computing devices directly without using a separate computing device like the sever computer 150.

While the external sounds are delivered from the loudspeakers to the attendees through the air in the form of sound waves, the stream of audio signals are transmitted through the communication channel in electromagnetic waves at a significantly faster speed. Therefore, an attendee may potentially hear the same audio content from the two paths with a discernible time delay, especially at a large venue. Accurate synchronization of the external sounds and the playback sounds can be achieved in a variety of manners particularly by delaying the sound signals related to the communication channels. The present disclosure is not limited to any particular synchronization mechanism.

In an exemplary embodiment, such a time delay can be determined and compensated based on a calculated distance between a mobile device user-attendee and a particular loudspeaker. The distance may be determined by utilizing a built-in microphone of a mobile device and periodically transmitting a specified frequency pulse from the loudspeakers at a known time/period. The time taken to reach the built-in microphone can yield the actual distance between the microphone and the speaker. Based on the distance, a corresponding application program on the mobile computing device can then delay the playback or buffer the output to the earphones by the appropriate value to bring the mobile device output in phase with the external sounds heard by the attendee. Thereby, the latency caused by the travel speed difference through the two audio paths can be eliminated.

As will be appreciated by those skilled in the art, the buffering may include one or more of receiving, encoding, compressing, encrypting, and writing audio data to a storage device associated with the mobile computing device; and playback may include retrieving the audio data from the storage device and one or more of decrypting, decoding, decompressing, and outputting the audio signal to an audio rendering device.

In some embodiments, the positional signals used to determine the attendee distance to the closest loudspeaker may have frequencies out of the spectrum of audible sound to avoid disturbing the attendee's enjoyment of the performance. In some embodiments, each of the on-stage microphones, or loudspeakers, may successively emit such a positional pulse. As a result, the location of a particular mobile device with reference to each, or the closest, loudspeaker can be determined.

In some embodiment, the mobile computing device may comprise some other transceiver designated to detect the pulses from the loudspeakers. In some other embodiment, a built-in GPS or another type of location transceiver in the mobile computing device can be used to detect the location of the associated mobile computing device with reference to the on-stage loudspeakers.

In still some other embodiments, a time delay can be estimated based on a seat number input by the attendee, assuming each seat number corresponds to a known location with reference to the loudspeaker.

As will be appreciated by those skilled in the art, the synchronization methods may also be implemented in the server computer, the mixing desk, or alike. Synchronization may be executed automatically each time the built-in microphone detects a pulse sent from the loudspeaker. In some other embodiments, synchronization may only be executed on a mobile device based on a predetermined period or when it is detected that the mobile device moves beyond a predetermined distance from its previous location. An attendee may also be able to force immediate synchronization through a graphic user interface (GUI) associated with the synchronization program.

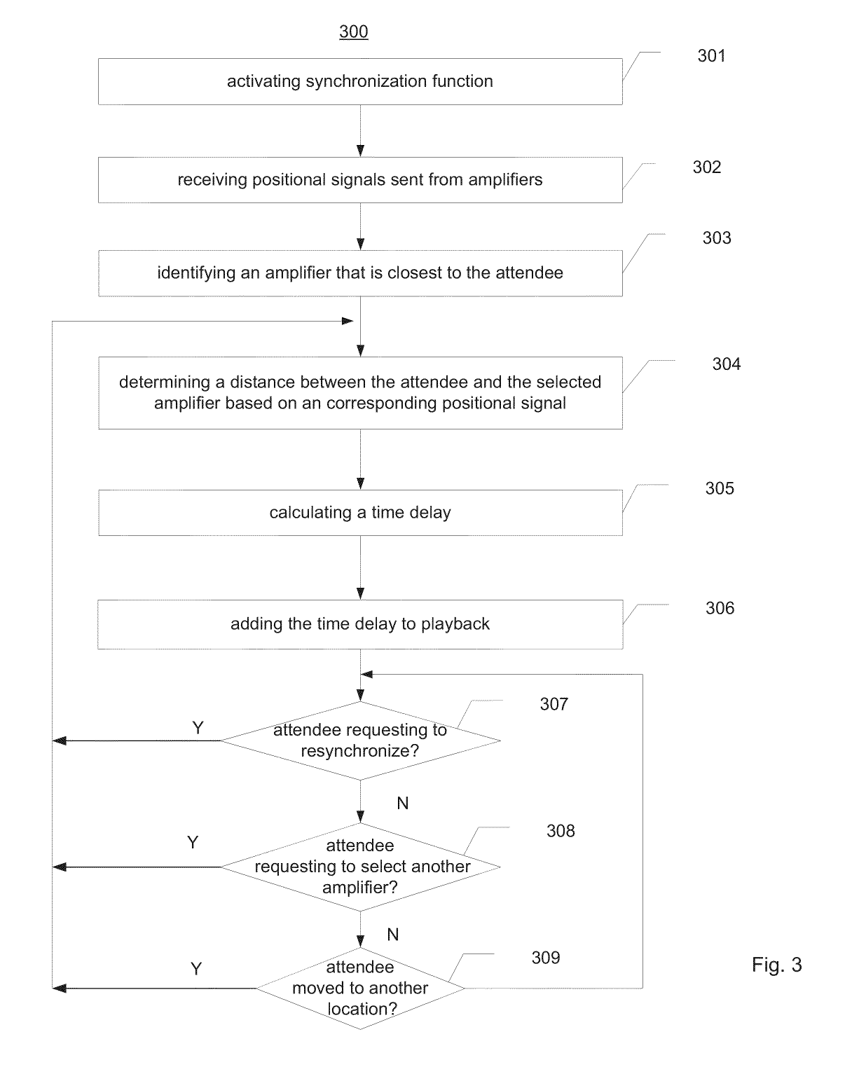

FIG. 3 is a flow chart depicting an exemplary computer implemented method 300 of synchronizing the output of the earphone (or the playback) and the external sounds heard by an attendee in accordance with an embodiment of the present disclosure. At 301, the synchronization function may be activated, such as manually by the attendee or periodically. At 302, the mobile computing device receives positional signals of known frequency and/or known intensity from all the loudspeakers. At 303, since that the attendee may mainly receive the external sounds emitted from the closet loudspeaker due to the high volume, this loudspeaker is selected and its location is used for time delay calculation. At 304, the distance between the attendee and the selected loudspeaker is determined based the corresponding positional signal, from which a time delay is derived at 305. The positional signals may encode a timestamp indicating the precise time of transmission at the loudspeaker. The mobile computing device may decode the timestamp once receiving the positional signal via the microphone on the mobile device. The mobile device may then compare the instant time to the timestamp and thereby compute the time difference or delay.

At 306, the time delay is added to the playing back of the audio data received by the mobile device to bring the output of the earphone and the external sounds in phase. In the events that an attendee sends an instruction for immediate resynchronizing at 307, requests to select another loudspeaker at 308, or moves to another location at 309, the foregoing steps 304-306 may be repeated.

To suit to an individual attendee's preference on a specific combination of the live external sound and the enhanced effect sounds provided by a mobile device, the volume levels of the mobile device output may need to be adjusted to match the volume level of the external sounds. The attendees can adjust the volume of the playback manually until a balanced level is achieved. In some embodiments, the mobile computing device may be able to automatically adjust the playback volume level to attain or to maintain an appropriate balance.

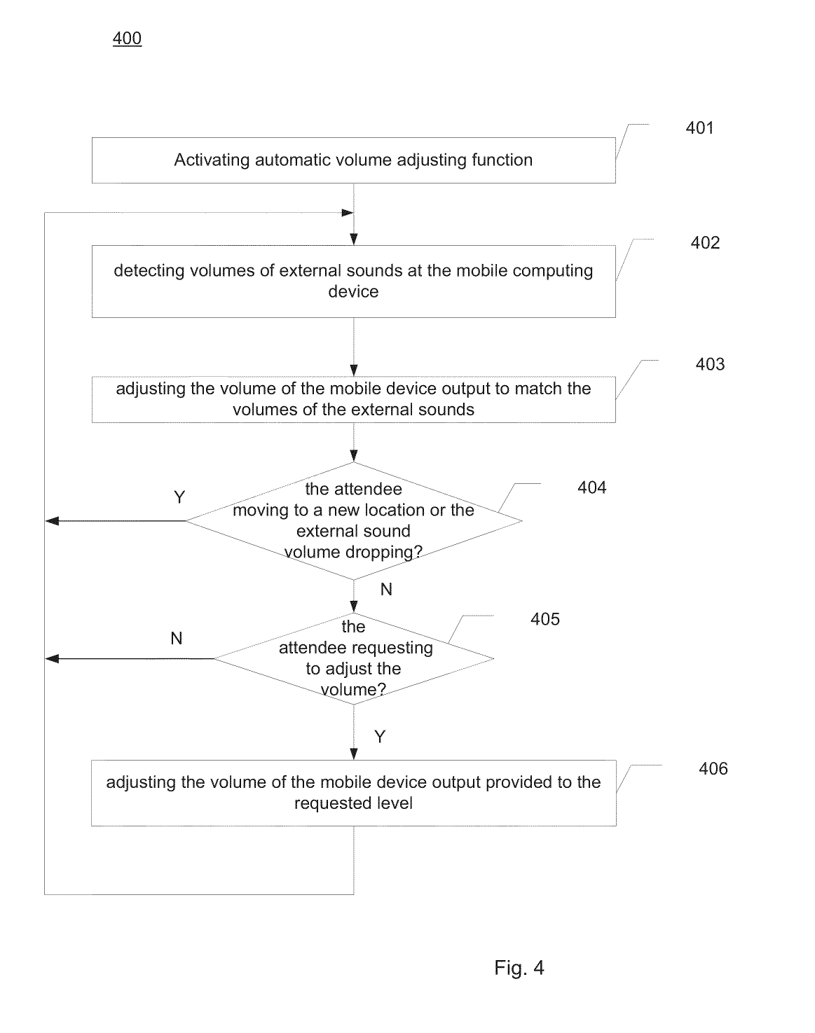

FIG. 4 is a flow chart depicting an exemplary method 400 of balancing the volume levels of the mobile device output and the external sounds heard by an attendee in accordance with an embodiment of the present disclosure. At 401, the automatic volume adjusting function is activated. At 402, a volume level of the external sounds is detected, for example by the built-in microphone of the mobile computing device. At 403, the volume level of the mobile device output is adjusted automatically to match the volume level of the external sounds in accordance with a predetermined formula. If it is detected that the volume of the external sounds changes at 404, for instance due to the attendee or a performer's movement, the foregoing steps 402-403 are repeated to readjust the balance. Moreover, if the attendee requests manual adjustment 404, the volume level of the mobile device output can adjusted to the requested level at 405. The manually adjusted volume can then be relatively maintained by raising or lowering it depending on the detected ambient sound volume.

Provided with the series of audio output from the mixing desk, including separate mixer groups and channels, the mobile computing device in accordance with some embodiments of the present disclosure may render further processing in accordance with an attendee's instructions. Thereby the attendee may advantageously hear the performance with enhanced audio effects tailored to his or her taste.

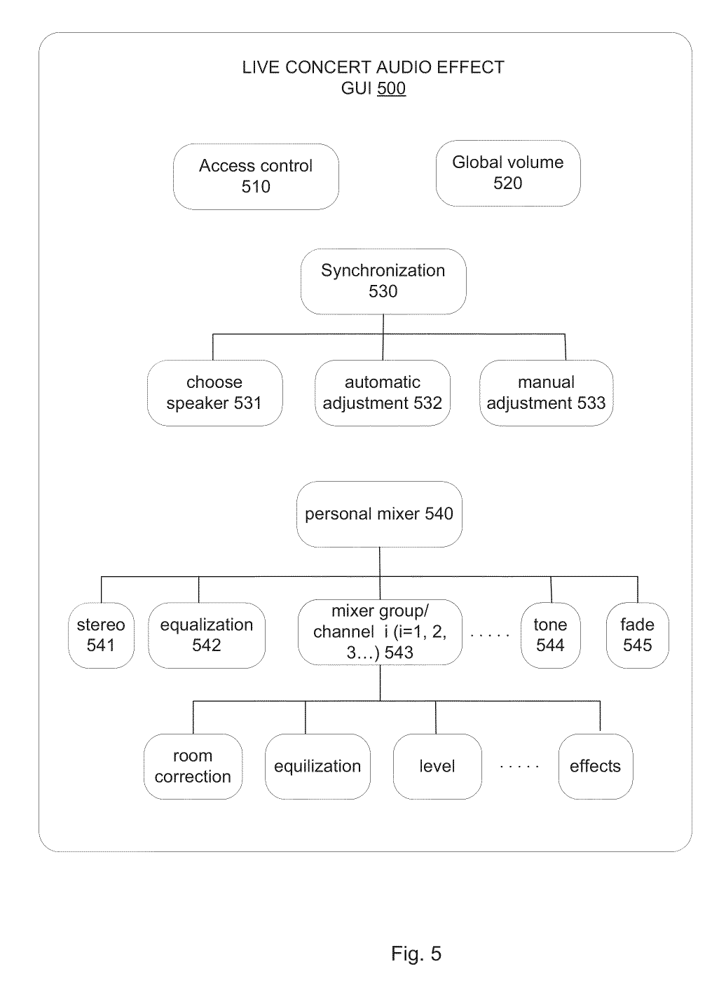

FIG. 5 illustrates an exemplary on-screen GUI 500 configured to receive user controls to personalize sound effects of the mobile computing device audio output in accordance with an embodiment of the present disclosure. The illustrated GUI includes control icons that can respectively prompt other GUIs allowing for access control, global volume, synchronization and personal mixing.

When a user selects the “access control” icon 510, another GUI (not shown) may be displayed allowing the user to input the access code so that he or she can use the mobile computing device to access the audio data transmitted from the server computer. By selecting the icon “global volume” 520, a related GUI (not shown) may present allowing a user to input the desired volume level of the playback sound.

The “synchronization” section 530 includes icons “choose speaker” 531, “automatic adjustment” 532, and “manual adjustment” 533 that are linked to respective GUIs. By selecting the “choose speaker” icon 531, another GUI (not shown) may be displayed allowing a user to manually select a loudspeaker from available options, or allowing automatic selection of a closest one after the user move to a different location. The “automatic adjustment” 532 and “manual adjustment” 533 respectively allows a user to force immediate automatic synchronization operations and to manually adjust the time delay added to the playback.

The “personal mixer” section 540 provides options for a user to control the external sound effects globally, e.g. through the icons “stereo” 541, “equalization” 542, “tone” 544, “fade” 545. In addition, the user can control the parameters of each mixer group or channel individually through the options connected to the “mixer group” icon 543. For instance, a mixer group 3 may correspond to the mixed sound of a drum and a bass on stage, or a channel 5 may correspond to the sound of a guitar. The variables for each mixer group or channel may include room correction, equalization, level, effects, etc, as illustrated.

An application program executable to process the audio data in response to user instructions can be stored and implemented in the mobile computing devices. Alternatively, as the mobile devices typically have limited battery power, in some other embodiments, the stated audio processing can be executed at a server computer, e.g. 150 in FIG. 1. In this manner, the mobile computing devices are used as a control interface to send user instructions to the server computer.

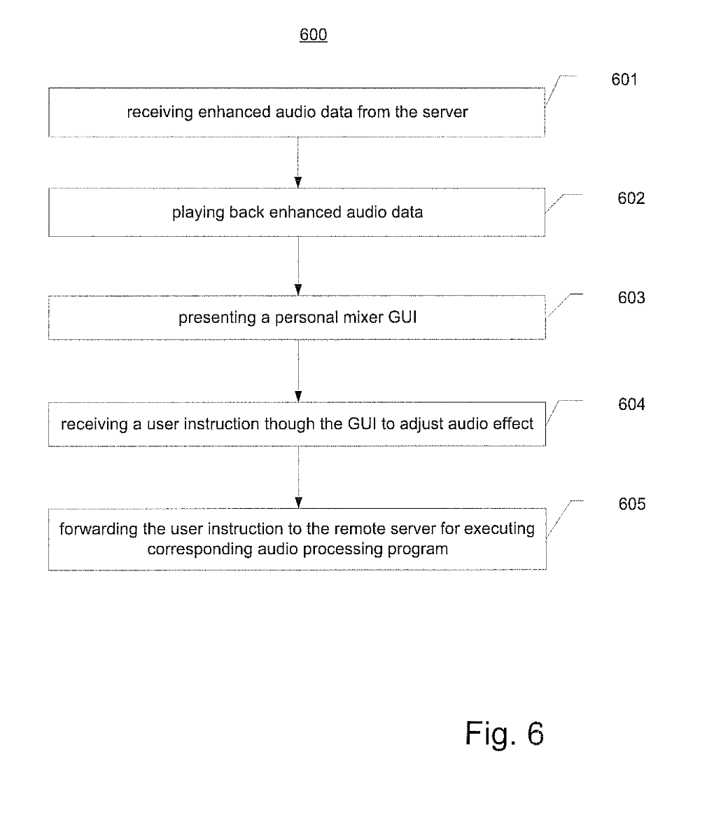

FIG. 6 is a flow chart depicting an exemplary method 600 to provide personalized audio effect to an attendee during a live event by using a mobile computing device in accordance with an embodiment of the present disclosure. At 601, the mobile device receives audio data from the sever computer. A live audio effect GUI that has a similar configuration as in FIG. 5 is presented at 602. Through the GUI, the mobile device may receive a user instruction to adjust a particular audio effect at 603 as described with reference to FIG. 5. At 604, the mobile device forwards the user instruction to the server computer through the network, as illustrated in FIG. 1. In response to the user instruction, the server computer can then further process the audio data to achieve desired effects and output the resulted audio data. The process 600 can then repeat.

The methods of providing enhanced audio effects to an attendee at a live event in accordance with the present disclosure can be implemented in smartphones, laptops, personal digital assistances, media players, touchpads, or any device alike that an attendee carries to the live event.

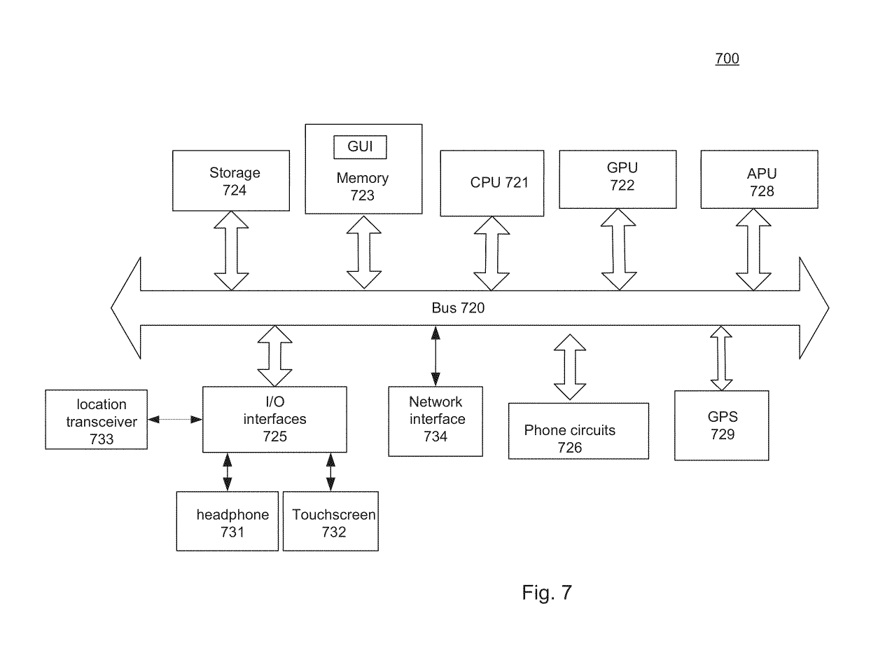

FIG. 7 is a block diagram illustrating an exemplary configuration of a mobile computing device 700 that can be used to provide live audio with enhanced audio effects to a user in accordance with an embodiment of the present disclosure. In some embodiments, the mobile computing device 700 can provide computing, communication as well as media playback capability. The mobile computing device 700 can also include other components (not explicitly shown) to provide various enhanced capabilities.

According to the illustrated embodiment in FIG. 7, the mobile computing system 700 comprises a main processor 721, a memory 723, an Graphic Processing Unit (GPU) 722 for processing graphic data, an Audio Processing Unit (APU) 728 for processing audio data, network interface 734, a storage device 724, a Global Positioning System (GPS) 729, phone circuits 726, I/O interfaces 725, and a bus 720, for instance. The I/O interface 725 comprises an earphone I/O interface 731, a touch screen I/O interface 732, and a location transceiver I/O interface 733.

The main processor 721 can be implemented as one or more integrated circuits and can control the operation of mobile computing device 400. In some embodiments, the main processor 721 can execute a variety of operating systems and software programs and can maintain multiple concurrently executing programs or processes. The storage device 724 can store user data and application programs to be executed by main processor 721, such as the live audio effect GUI programs, video game programs, personal information data, media play back programs. The storage device 724 can be implemented using disk, flash memory, or any other non-volatile storage medium.

Network or communication interface 734 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 734 can provide wired network connectivity instead of or in addition to a wireless interface. Network interface 734 can be implemented using a combination of hardware, e.g. antennas, modulators/demodulators, encoders/decoders, and other analog/digital signal processing circuits, and software components.

I/O interfaces 725 can provide communication and control between the mobile computing device 400 and the touch screen panel 433 and other external I/O devices (not shown), e.g. a computer, an external speaker dock or media playback station, a digital camera, a separate display device, a card reader, a disc drive, in-car entertainment system, a storage device, user input devices or the like. The processor 721 can then execute pertinent GUI instructions, such as the live audio effect GUI as in FIG. 5, stored in the memory 723 in accordance with the converted location signals.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A mobile computing device comprising:
a processor coupled to a memory and a bus;
a display panel coupled to said bus;
an audio rendering device;
an Input/Output (I/O) interface configured to receive enhanced audio signals from a communication network, said enhanced audio signals representing external sounds that are substantially contemporaneously audible to a user and comprising enhanced audio effects relating thereto, wherein said enhanced audio signals are provided by a remote audio signal processing device; and
a memory resident application configured to play back said enhanced audio signals in phase with said external sounds using said audio rendering device.

2. The mobile computing device of claim 1, wherein said external sounds comprise music content and/or speech content, wherein further said external sounds are emitted by a loudspeaker used in a context selected from a group consisting of a live performance, a home entertainment system, a conference, an assembly, a sport event, and a new reporting event.

3. The mobile computing device of claim 2, wherein said remote audio signal processing device comprises a mixing console coupled with said loudspeaker, wherein said mixing console is further coupled with a server device that is further coupled to said communication network.

4. The mobile computing device of claim 1, wherein said communication network comprises a wireless local area network (LAN).

5. The mobile computing device of claim 1, wherein said audio rendering device comprises an earphone configured to render said enhanced audio signals to a user.

6. The mobile computing device of claim 5 further comprising an audio detecting device, and wherein said memory resident application is operable to adjust a volume of said enhanced audio signals to balance said volume level of said enhanced audio signals with a contemporaneously detected volume level of said audio detecting device.

7. The mobile computing device of claim 5 further comprising a microphone, and wherein said memory resident application is configured to: determine a distance between said mobile computing device and a loudspeaker that emits said external sounds; and add a time delay to said enhanced audio signals based on said distance.

8. The mobile computing device of claim 5,
wherein said enhanced audio signals comprise a plurality of channels of audio signals, each channel corresponding to one or more audio sources generating external sounds; and
wherein said memory resident application comprises a graphic user interface (GUI) configured to send user requests to said server device through said communication network to adjust audio effects for said plurality of channels of audio signals.

9. The mobile computing device of claim 5, wherein said enhanced audio effects comprise stereo effects.

10. A computer implemented method of providing real-time audio with enhanced sound-effects using a portable computing device, said method comprising:
receiving real-time audio data from a communication network at said portable computing device, said real-time audio data representing concurrent external sounds that are audible to a user of said portable computing device and comprising enhanced sound-effects relating thereto, said real time audio data provided by a remote audio production console; and
using a memory resident application to play back said real-time audio data, wherein said playing back is in phase with said concurrent external sounds.

11. The method of claim 10 wherein said using comprises:
determining a distance between said portable computing device and a sound source of said concurrent external sounds based on a positional signal;
deriving a time delay based on said distance; and
adding said time delay to said playing back said real-time audio data.

12. The method of claim 11 further comprising adjusting said time delay in response to user instructions, wherein said user instructions comprise instructions to select a sound source.

13. The method of claim 11 further comprising: using said memory resident application to balance volume levels of said playing back of said real-time audio data with a detected volume level of said concurrent external sounds.

14. The method of claim 11 further comprising: receiving a user request at said portable computing device to adjust said real-time audio data and forwarding said user request through said communication network to a remote computing device, wherein said remote computing device is coupled with said audio production console and operable to further adjust sound-effects to said real-time audio data in response to said user request.

15. A tangible non-transient computer readable storage medium having instructions executable by a processor, said instructions performing a method comprising:
rendering a graphic user interface (GUI);
receiving real-time audio data from a communication network at a portable computing device comprising said processor, said real-time audio data representing concurrent external sounds that are audible to a user of said portable computing device and comprising enhanced sound-effects relating thereto, said real-time audio data provided by a remote audio production console; and
playing back said real-time audio data substantially in phase with said concurrent external sounds.

16. The tangible non-transient computer readable storage medium of claim 15, wherein said method further comprises:
determining a time delay based on distance between said portable computing device and a sound source of said concurrent external sounds based on a positional signal, said positional signal comprising a known frequency and known intensity; and
adding said time delay to said playing back said real-time audio data.

17. The tangible non-transient computer readable storage medium of claim 16, wherein said method further comprises balancing volume levels of said real-time audio data being played back with detected volume levels of said concurrent external sounds.

18. The tangible non-transient computer readable storage medium of claim 16, wherein said method further comprises forwarding a user request received at said portable computing device to a remote computing device through said communication network, wherein said remote computing device is coupled with said audio product console and operable to further adjust sound-effects to said real-time audio data in response to said user request.

19. The tangible non-transient computer readable storage medium of claim 16, wherein said concurrent external sounds are generated by an amplifier coupled with an on-stage microphone used by a performer during a live concert; wherein said remote computing device is located at a venue of said live concert.

20. The tangible non-transient computer readable storage medium of claim 19,
wherein said real-time audio data comprises a plurality of channels, each channel associated with a respective on-stage microphone; and
wherein said method further comprises forwarding user instructions to said remote computing device to modify sound-effects of a respective channel.
